(19) United States
(12) Patent Application Publication
(10) Pub. No.: US 2022/0231329 A1
(43) Pub. Date: Jul. 21, 2022

(54) COIN-TYPE ALL-SOLID-STATE BATTERY AND METHOD OF MANUFACTURING THE SAME

(71) Applicant: HONDA MOTOR CO., LTD., Tokyo (JP)

(72) Inventors: Toshiyuki ARIGA, Saitama (JP); Takuya TANIUCHI, Saitama (JP); Masahiro OHTA, Saitama (JP); Toshimitsu TANAKA, Saitama (JP); Kiyoshi TANAAMI, Saitama (JP)

(21) Appl. No.: 17/577,356

(22) Filed: Jan. 17, 2022

(30) Foreign Application Priority Data
Jan. 19, 2021 (JP) 2021-006216

(51) Int. Cl. H01M 10/0562; H01M 10/04; H01M 50/109; H01M 50/153; H01M 50/169; H01M 4/76; H01M 4/66

(52) U.S. Cl. CPC H01M 10/0562; H01M 10/0427; H01M 50/109; H01M 2004/021; H01M 50/169; H01M 4/762; H01M 4/666; H01M 50/153

(57) ABSTRACT

To provide a current collecting structure capable of reliably collecting current while maintaining a pressurized and constrained state of a coin-type all-solid-state battery. A coin-type all-solid-state battery includes a solid electrolyte layer; a pair of first electrode current collectors each including a metal porous body, the first electrode current collectors being respectively disposed on both sides of the solid electrolyte layer; a pair of second electrode current collectors each including a metal porous body, the second electrode current collectors being respectively disposed on outer sides of the first electrode current collectors; and a pair of lid members being respectively disposed on outer sides of the pair of second electrode current collectors.

This application is based on and claims the benefit of priority from Japanese Patent Application No. 2021-006216, filed on 19 Jan. 2021, the content of which is incorporated herein by reference.

### BACKGROUND OF THE INVENTION

### Field of the Invention

The present invention relates to a coin-type all-solid-state battery and a method of manufacturing the same.

### Related Art

Conventionally, lithium ion secondary batteries have been widely used as secondary batteries having a high energy density. In the case of a solid-state battery where the electrolyte is solid, the battery has a cell structure in which a solid electrolyte is present between a positive electrode and a negative electrode.

In the case of a solid-state battery, sufficient adhesion is required between an electrode material mixture containing a positive electrode active material or a negative electrode active material and a solid electrolyte from the viewpoint of maintaining the ionic conductivity of lithium ions or the like. If the adhesion decreases due to repeated expansion and contraction during charging and discharging, ionic conductivity decreases. Therefore, the electrode material mixture and the solid electrolyte need to be constrained in a pressurized state by pressing or other means.

In the case of a coin-type all-solid-state battery, an electrode stack is sandwiched between a top metallic lid member and a bottom metallic receiving member, which serve as current collecting electrodes, and the stack is integrated by applying pressure from the top lid member side and the bottom receiving member side, to construct a coin-shaped all-solid-state battery. Accordingly, it is difficult to efficiently collect current while maintaining the above pressurized and constrained state.

In this regard, for example, Patent Document 1 discloses a coin-type all-solid-state battery in which conductive layers each including a porous metal are provided above and below an electrode stack to improve the adhesion between the conductive layers and the electrode stack.
Patent Document 1: Japanese Unexamined Patent Application, Publication No. 2005-056827

### SUMMARY OF THE INVENTION

However, even in Patent Document 1, the bonding between the porous metal and the electrode stack is insufficient, and a more reliable and simple current collecting structure is required.

In response to the above issue, it is an object of the present invention to provide a current collecting structure capable of reliably collecting current while maintaining a pressurized and constrained state of a coin-type all-solid-state battery.

The inventors have found that the above issue can be solved by respectively disposing current collectors each including a metal porous body on the bonding faces of the electrode stack and the lid member (receiving member), making them face each other and pressure-bonding and integrating them. That is, the present invention provides the following.

(1) A first aspect of the present invention relates to a coin-type all-solid-state battery. The coin-type all-solid-state battery includes a solid electrolyte layer; a first electrode current collector of a positive electrode and a first electrode current collector of a negative electrode each including a metal porous body, the first electrode current collectors being respectively disposed on both sides of the solid electrolyte layer; a second electrode current collector of the positive electrode and a second electrode current collector of the negative electrode each including a metal porous body, the second electrode current collectors being respectively disposed on outer sides of the first electrode current collectors of the positive electrode and the negative electrode; and a lid member and a receiving member each capable of collecting current, the lid member and the receiving member being respectively disposed on outer sides of the second electrode current collectors of the positive electrode and the negative electrode. The first electrode current collector has a first face having an electrode material mixture filled region including an electrode material mixture that fills pores of the metal porous body, the first face being in contact with the solid electrolyte layer. The first electrode current collector has a second face having an electrode material mixture non-filled region not including the electrode material mixture. The electrode material mixture non-filled region of the first electrode current collector and the second electrode current collector are pressure-bonded.

According to the invention of the first aspect, the electrode material mixture non-filled region of the first electrode current collector and the second electrode current collector, which each include a metal porous body, are intertwined with each other and compression bonded by pressure bonding. In addition, the bonding is stabilized by the anchor effect between the surface irregularities of the electrode material mixture non-filled region of the first electrode current collector and the surface irregularities of the second electrode current collector. Therefore, when expansion and contraction repeatedly occur during charging and discharging, the elasticity of the metal porous bodies can provide a followability effect, thus suppressing a decrease in the current collecting effect.

(2) In a second aspect of the present invention according to the first aspect, a first of the second electrode current collectors and the lid member are bonded to each other by ultrasonic welding or welding, and a second of the second electrode current collectors and the receiving member are bonded to each other by ultrasonic welding or welding.

According to the invention of the second aspect, the second electrode current collectors can be respectively firmly bonded to the inner side of the lid member and the inner side of the receiving member, so that a decrease in the current collecting effect can be further suppressed.

(3) In a third aspect of the present invention according to the first or second aspect, bonding faces of the electrode material mixture non-filled region of the first electrode current collector and the second electrode current collector that are pressure-bonded, respectively include an engagement projection and an engagement recess that engage with each other.

According to the invention of the third aspect, engagement of the recess and the projection on the bonding faces facilitates positioning and prevents misalignment of the boding faces.

(4) A fourth aspect of the present invention relates to a method of manufacturing a coin-type all-solid-state battery. The method includes a first step of obtaining each of a first electrode current collector of a positive electrode and a first electrode current collector of a negative electrode by filling pores of a metal porous body with an electrode material mixture to form an electrode material mixture filled region on a first face of the metal porous body, and forming an electrode material mixture non-filled region not including the electrode material mixture on a second face of the metal porous body; a second step of obtaining an electrode stack by respectively bonding the first electrode current collector of the positive electrode and the first electrode current collector of the negative electrode to both sides of a solid electrolyte layer so that the electrode material mixture filled regions face each other; a third step of obtaining a current collector of the positive electrode and a current collector of the negative electrode by respectively bonding a lid member and a receiving member to first faces of second electrode current collectors each including another metal porous body; and a fourth step of respectively making the electrode material mixture non-filled regions of the first electrode current collectors after the second step and second faces of the second electrode current collectors after the third step face each other and pressure-bonding the electrode material mixture non-filled regions of the first electrode current collectors and the second faces of the second electrode current collectors from at least a side of the lid member or the receiving member to integrate them.

According to the invention of the manufacturing method of the fourth aspect, integration by pressure bonding is possible, which eliminates the need for other bonding means such as welding, thereby simplifying the manufacturing of coin-type all-solid-state batteries and improving productivity.

(5) In a fifth aspect of the present invention according to the fourth aspect, an engagement projection and an engagement recess that engage with each other are respectively formed on a surface of the electrode material mixture non-filled region in the first step and a second face of the second electrode current collector in the third step. In the fourth step, the pressure bonding is performed in a state in which the engagement recess and the engagement projection are engaged with each other.

According to the invention of the fifth aspect, the engagement of the recess and the projection on the bonding faces prevents misalignment of the bonding faces.

### BRIEF DESCRIPTION OF THE DRAWINGS

FIG. 1 is a cross-sectional schematic diagram showing an embodiment of a coin-type all-solid-state battery of the present invention;

FIG. 2 is an exploded view before pressure bonding in FIG. 1; and

FIG. 3 is an exploded view of a modification of FIG. 2.

### DETAILED DESCRIPTION OF THE INVENTION

Embodiments of the present invention will now be described with reference to the drawings. The present invention is not limited to the following embodiments. In the following embodiments, a solid-state lithium ion battery will be used as an example, but the present invention can be applied to batteries other than lithium ion batteries.

### First Embodiment

### <Overall Structure of Coin-Type All-Solid-State Battery>

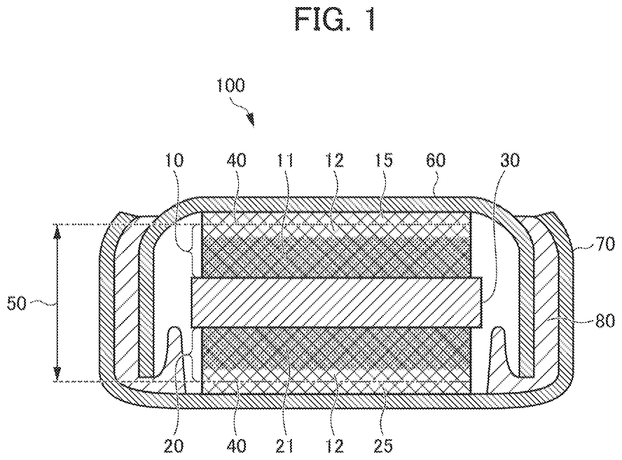

As shown in FIG. 1, a coin-type all-solid-state battery 100 according to this embodiment is a circular planar body as a whole in plan view. An electrode stack 50 is disposed between a lid member 60 and a receiving member 70, which also serve as outer packaging containers and current collecting electrodes. The lid member 60 and the receiving member 70 are concave-shaped to each other by a caulking process after pressure bonding, and are fitted to each other and integrated. An insulator 80 is disposed in the gap therebetween. In this state, the lid member 60 and the receiving member 70 respectively constitute the external electrodes of a positive electrode and a negative electrode of the battery.

In the electrode stack 50, a first electrode current collector 10 that forms the positive electrode, a solid electrolyte layer 30, and a first electrode current collector 20 that forms the negative electrode are arranged in a stack in this sequence. The first electrode current collector 10 of the positive electrode is entirely composed of a metal porous body, and has a bonding face to the solid electrolyte layer 30 including a metal porous body. The bonding face has an electrode material fixture filled region 11, which is filled with a positive electrode material mixture to form a positive electrode material mixture layer. The face opposite to the bonding face constitutes an electrode material mixture non-filled region 12 consisting only of the metal porous body. Similarly, the first electrode current collector 20 of the negative electrode is entirely composed of a metal porous body, and includes an electrode material fixture filled region 21, which is filled with a negative electrode material mixture to form a negative electrode material mixture layer, and an electrode material mixture non-filled region 22 consisting only of the metal porous body.

In other words, the electrode stack 50 has a layer structure of the electrode material mixture non-filled region 12 of the positive electrode, the electrode material mixture filled region 11 of the positive electrode, the solid electrolyte layer 30, the electrode material mixture filled region 21 of the negative electrode, and the electrode material mixture non-filled region 22 of the negative electrode.

A second electrode current collector 15 of the positive electrode is bonded to the inner side of the lid member 60. A second electrode current collector 25 of the negative electrode is bonded to the inner side of the receiving member 70. The electrode material mixture non-filled region 12 of the positive electrode and the second electrode current collector 15 of the positive electrode are compression bonded at bonding faces 40. The electrode material mixture non-filled region 22 of the negative electrode and the second electrode current collector 25 of the negative electrode are compression bonded at bonding faces 40.

The respective components will be described below.

### <Positive Electrode and Negative Electrode>

In this embodiment, the first electrode current collectors 10 and 20 each constitutes a current collector including a metal porous body having pores (communicating pores) that are continuous with each other. Pores of each of the current collectors are filled with an electrode material mixture (positive electrode material mixture or negative electrode material mixture) including an electrode active material.

### (Current Collector)

The current collector includes a metal porous body having pores that are continuous with each other. The porosity is preferably 50% or more and 99% or less. Having pores that are continuous with each other allows the pores to be filled with a positive electrode material mixture or a negative electrode material mixture containing an electrode active material, thereby increasing the amount of the electrode active material per unit area of the electrode layer. The form of the metal porous body is not limited as long as it has pores that are continuous with each other. Examples of the form of the metal porous body include a foam metal having pores by foaming, a metal mesh, an expanded metal, a punching metal, and a metal nonwoven fabric.

The metal used in the metal porous body is not limited as long as it has electric conductivity. Examples thereof include nickel, aluminum, stainless steel, titanium, copper, and silver. Among these, as the current collector constituting the positive electrode, a foamed aluminum, foamed nickel, and foamed stainless steel are preferable. As the current collector constituting the negative electrode, a foamed copper and foamed stainless steel are preferable.

By using the current collector including the metal porous body, the amount of the active material per unit area of the electrode can be increased, and as a result, the volumetric energy density of the lithium ion secondary battery can be improved. In addition, since the positive electrode material mixture and the negative electrode material mixture are easily fixed, it is not necessary to thicken a coating slurry for forming the electrode material mixture layer when the electrode material mixture layer is thickened, unlike a conventional electrode including a metal foil as a current collector. Accordingly, it is possible to reduce a binder such as an organic polymer compound that has been necessary for thickening. Therefore, the capacity per unit area of the electrode can be increased, and a higher capacity of the lithium ion secondary battery can be achieved.

### (Electrode Material Mixture)

The positive electrode material mixture and the negative electrode material mixture are respectively disposed in the pores formed within the current collectors. The positive electrode material mixture and the negative electrode material mixture respectively contain a positive electrode active material and a negative electrode active material as an essential component.

### (Electrode Active Material)

The positive electrode active material is not limited as long as it can occlude and release lithium ions. Examples thereof include LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.09})O₂, Li(Ni_{1/6}Co_{4/6}Mn_{1/6})O₂, Li(Ni_{1/3}Co_{1/3}Mn_{1/3})O₂, Li(Ni_{1/3}Co_{1/3}Mn_{1/3})O₂, LiCoO₄, LiMn₂O₄, LiNiO₂, LiFePO₄, lithium sulfide, and sulfur.

The negative electrode active material is not limited as long as it can occlude and release lithium ions. Examples thereof include metallic lithium, lithium material mixtures, metal oxides, metal sulfides, metal nitrides, Si, SiO, and carbon materials such as artificial graphite, natural graphite, hard carbon, and soft carbon.

### (Other Components)

The electrode material mixture may optionally include components other than an electrode active material and ionic conductive particles. The other components are not limited, and can be any components that can be used in fabricating a lithium ion secondary battery. Examples thereof include a conductivity aid and a binder. The conductivity aid of the positive electrode is, for example, acetylene black, and the binder of the positive electrode is, for example, polyvinylidene fluoride. Examples of the binder of the negative electrode include sodium carboxyl methyl cellulose, styrene-butadiene rubber, and sodium polyacrylate.

### <Solid Electrolyte Layer>

The solid electrolyte constituting the solid electrolyte layer 30 is not limited, and is, for example, a sulfide solid electrolyte material, an oxide solid electrolyte material, a nitride solid electrolyte material, or a halide solid electrolyte material. Examples of the sulfide solid electrolyte material include LPS halogens (Cl, Br, and I), Li₂S—P₂S₅, and Li₂S—P₂S₅—LiI for lithium ion batteries. The above-described “Li₂S—P₂S₅” refers to a sulfide solid electrolyte material including a raw material composition containing Li₂S and P₂S₅, and the same applies to the “Li₂S—P₂S₅—LiI”. Examples of the oxide solid electrolyte material include NASICON-type oxides, garnet-type oxides, and perovskite-type oxides for lithium ion batteries. Examples of the NASICON-type oxides include oxides containing Li, Al, Ti, P, and O (e.g., Li_{1.5}Al_{0.5}Ti_{1.5}(PO₄)₃). Examples of the garnet-type oxides include oxides containing Li, La, Zr, and O (e.g., Li₇La₃Zr₂O₁₂). Examples of the perovskite-type oxides include oxides containing Li, La, Ti, and O (e.g., LiLaTiO₃).

### <Method of Manufacturing Coin-Type All-Solid-State Battery>

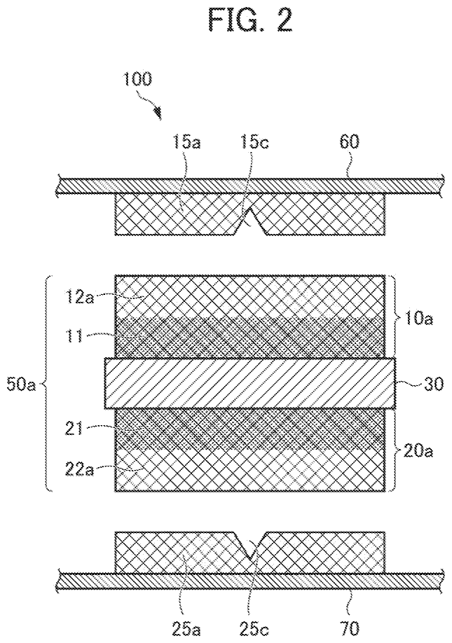

The coin-type all-solid-state battery 100 will be described in detail in line with the manufacturing method with reference to the exploded view shown in FIG. 2. FIG. 2 is an exploded view of an example of the manufacturing method of the present invention.

### (First Step)

A first step is a step of obtaining a first electrode current collector 10a of the positive electrode and a first electrode current collector 20a of the negative electrode. Specifically, on first faces of metal porous bodies, pores are filled with electrode material mixtures to form electrode material mixture filled regions 11 and 21. On second faces, electrode material mixture non-filled regions 12a and 22a not including the electrode material mixtures are formed. Thus, the first electrode current collector 10a of the positive electrode and the first electrode current collector 20a of the negative electrode are obtained.

The first electrode current collectors 10a and 20a are each obtained by filling the pores only on the first face of the metal porous body having pores that are continuous with each other as a current collector with the electrode material mixture. First, an electrode active material and, if necessary, a binder and a conductivity aid, are uniformly mixed by a conventionally known method, and thus an electrode material mixture composition adjusted to a predetermined viscosity, preferably in the form of a paste, is obtained.

Subsequently, pores of a metal porous body, which is a current collector, are filled with the above electrode material mixture composition as an electrode material mixture. The method of filling the current collector with the electrode material mixture is not limited, and is, for example, a method of filling the pores of the current collector with a slurry containing the electrode material mixture by applying pressure using a plunger-type die coater. As an alternative, the interior of the metal porous body may be impregnated with an ion conductor layer by a dipping method. At this time, by filling the electrode material mixtures only from the first faces of the metal porous bodies, it is possible to obtain the first electrode current collectors each including the electrode material mixture filled region 11 (21) and the electrode material mixture non-filled region 12a (22a).

### (Second Step)

A second step is a step of obtaining an electrode stack 50a. The first electrode current collectors 10a and 20a are respectively attached to both sides of the solid electrolyte layer 30 so that the electrode material mixture filled regions 11 and 21 face each other, and thereby the electrode stack 50a is formed.

### (Third Step)

In a third step, the lid member 60 is stacked on a first face of a second electrode current collector 15a including a metal porous body, to obtain a positive electrode current collector. Similarly, the receiving member 70 is stacked on a first face of a second electrode current collector 25a including a metal porous body, to obtain a negative electrode current collector. The stacking is preferably performed by bonding under pressure, such as ultrasonic welding or resistance welding. As a result, each of the metal porous bodies is compressed by pressing at the time of bonding, and is bonded to the lid member 60 or the receiving member 70 in a high-density state, which is expected to improve the strength of the bonding portions. At this time, recesses 15c and 25c are respectively formed on the second electrode current collectors 15a and 25a by pressing at the time of bonding.

### (Fourth Step)

Finally, the electrode material mixture non-filled region 12a of the first electrode current collector after the second step and the second electrode current collector 15a after the third step are disposed to face each other to constitute the positive electrode side. Similarly, the electrode material mixture non-filled region 22a of the first electrode current collector after the second step and the second electrode current collector 25a after the third step are disposed to face each other to constitute the negative electrode side. In this state, they are bonded and integrated by applying pressure from above and below, i.e., from the lid member 60 and the receiving member 70 sides.

The pressure bonding can be performed by a conventionally known pressing process. At this time, when the lid member 60 and the receiving member 70 are integrated by the caulking process, the insulator 80 fills the space between the lid member 60 and the receiving member 70.

By the pressurization process, the electrode material mixture non-filled region 12a (22a) of the first electrode current collector and the part of the second electrode current collector 15a (25a) other than the recess 15c (25c) are compressed in a state in which their metal porous bodies are intertwined with each other to reduce their thickness. As shown in FIG. 1, the electrode material mixture non-filled region 12 (22) of the first electrode current collector and the second electrode current collector 15 (25) are compression bonded with the bonding faces 40 interposed therebetween. In this way, by pressure-bonding the metal porous bodies to form a current collector, even when expansion and contraction repeatedly occur during charging and discharging, as is the case with lithium ion batteries, the elasticity of the metal porous bodies can provide a followability effect, thus suppressing a decrease in the current collecting effect and extending the life span of the current collector.

### [Modification]

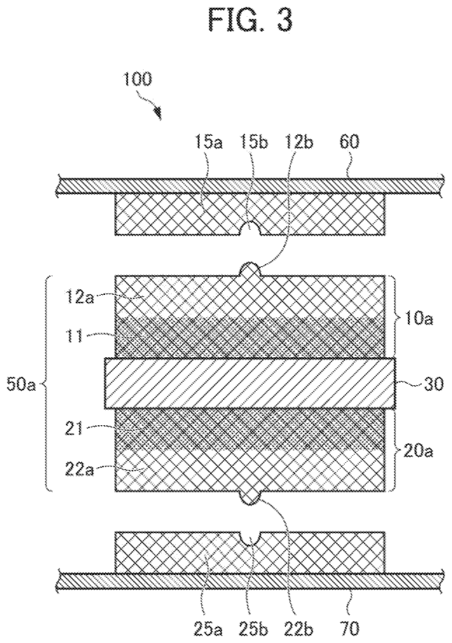

FIG. 3 shows a modification of FIG. 2. In this embodiment, a projection 12b is formed on a surface of an electrode material mixture non-filled region 12a, and a recess 15b is formed on a surface of a second electrode current collector 15a. The surfaces form bonding faces 40 during pressure-bonding. This is a difference from FIG. 2. The recess 15b and the projection 12b face each other to engage with each other. The same applies to a projection 22b formed on a surface of an electrode material mixture non-filled region 22a and a recess 25b formed on a surface of a second electrode current collector 25a, of a negative electrode side.

In this state, pressure bonding is performed in the fourth step so that the recess 15b (25b) and the projection 12b (22b) engage with each other, which facilitates alignment of the bonding faces and prevents misalignment of the bonding faces. The shapes, positions, and numbers of recess(es) and projection(s) that engage with each other are not limited.

Although preferred embodiments of the present invention have been described above, the present invention is not limited to the above embodiments and can be modified as appropriate.

### EXPLANATION OF REFERENCE NUMERALS

10 first electrode current collector (positive electrode)
10a first electrode current collector (positive electrode) before pressure bonding
11 electrode material mixture filled region (positive electrode material mixture layer)
12 electrode material mixture non-filled region (positive electrode)
12a electrode material mixture non-filled region (positive electrode) before pressure bonding
12b projection
15 second electrode current collector (positive electrode)
15a second electrode current collector (positive electrode) before pressure bonding
15b recess
15c recess
20 first electrode current collector (negative electrode)
20a first electrode current collector (negative electrode) before pressure bonding
21 electrode material mixture filled region (negative electrode material mixture layer)
22 electrode material mixture non-filled region (negative electrode)
22a electrode material mixture non-filled region (negative electrode) before pressure bonding
22b projection
25 second electrode current collector (negative electrode)
25a second electrode current collector (negative electrode) before pressure bonding
25b recess
25c recess
30 solid electrolyte layer
40 bonding face
50 electrode stack
50a electrode stack before pressure bonding
60 lid member
70 receiving member
80 insulator
100 coin-type all-solid-state battery

What is claimed is:

1. A coin-type all-solid-state battery, comprising:
a solid electrolyte layer;
a first electrode current collector of a positive electrode and a first electrode current collector of a negative electrode each comprising a metal porous body, the first electrode current collectors being respectively disposed on both sides of the solid electrolyte layer;
a second electrode current collector of the positive electrode and a second electrode current collector of the negative electrode each comprising a metal porous body, the second electrode current collectors being respectively disposed on outer sides of the first electrode current collectors of the positive electrode and the negative electrode; and
a lid member and a receiving member each capable of collecting current, the lid member and the receiving member being respectively disposed on outer sides of the second electrode current collectors of the positive electrode and the negative electrode,
the first electrode current collector having a first face having an electrode material mixture filled region comprising an electrode material mixture that fills pores of the metal porous body, the first face being in contact with the solid electrolyte layer,
the first electrode current collector having a second face having an electrode material mixture non-filled region not comprising the electrode material mixture, and
the electrode material mixture non-filled region of the first electrode current collector and the second electrode current collector being pressure-bonded.

2. The coin-type all-solid-state battery according to claim 1, wherein a first of the second electrode current collectors and the lid member are bonded to each other by ultrasonic welding or welding, and a second of the second electrode current collectors and the receiving member are bonded to each other by ultrasonic welding or welding.

3. The coin-type all-solid-state battery according to claim 1, wherein bonding faces of the electrode material mixture non-filled region of the first electrode current collector and the second electrode current collector that are pressure-bonded, respectively comprise an engagement projection and an engagement recess that engage with each other.

4. A method of manufacturing a coin-type all-solid-state battery, the method comprising:
a first step of obtaining each of a first electrode current collector of a positive electrode and a first electrode current collector of a negative electrode by filling pores of a metal porous body with an electrode material mixture to form an electrode material mixture filled region on a first face of the metal porous body, and forming an electrode material mixture non-filled region not comprising the electrode material mixture on a second face of the metal porous body;
a second step of obtaining an electrode stack by respectively bonding the first electrode current collector of the positive electrode and the first electrode current collector of the negative electrode to both sides of a solid electrolyte layer so that the electrode material mixture filled regions face each other;
a third step of obtaining a current collector of the positive electrode and a current collector of the negative electrode by respectively bonding a lid member and a receiving member to first faces of second electrode current collectors each comprising another metal porous body; and
a fourth step of respectively making the electrode material mixture non-filled regions of the first electrode current collectors after the second step and second faces of the second electrode current collectors after the third step face each other and pressure-bonding the electrode material mixture non-filled regions of the first electrode current collectors and the second faces of the second electrode current collectors from at least a side of the lid member or the receiving member to integrate them.

5. The method of manufacturing a coin-type all-solid-state battery according to claim 4,
wherein an engagement projection and an engagement recess that engage with each other are respectively formed on a surface of the electrode material mixture non-filled region in the first step and a second face of the second electrode current collector in the third step, and
wherein in the fourth step, the pressure bonding is performed in a state in which the engagement recess and the engagement projection are engaged with each other.
